(19) United States
(12) Patent Application Publication
(10) Pub. No.: US 2013/0222382 A1
(43) Pub. Date: Aug. 29, 2013

(54) Generating Hogel Beam Data from Voxel Data

(71) Applicants: Sean M. O'Connell, Austin, TX (US); Alexander Nankervis, Austin, TX (US); Thomas Burnett, III, Austin, TX (US)

(72) Inventors: Sean M. O'Connell, Austin, TX (US); Alexander Nankervis, Austin, TX (US); Thomas Burnett, III, Austin, TX (US)

(73) Assignee: ZEBRA IMAGING, INC., Austin, TX (US)

(21) Appl. No.: 13/598,557

(22) Filed: Aug. 29, 2012

Related U.S. Application Data
(60) Provisional application No. 61/528,737, filed on Aug. 29, 2011.

(51) Int. Cl. G06T 15/00

(52) U.S. Cl. CPC G06T 15/00
USPC 345/424

(57) ABSTRACT

Methods and systems for generating hogel data, including receiving a set of voxel data. The voxel data has a set of attributes that is dependent on one or more performance characteristics of a hogel light modulator that is configured to display the hogel data. Hogel data is generated using the voxel data and is displayed on the hogel light modulator.

### PRIORITY CLAIM

This patent application claims priority from previously filed provisional patent application filed on Aug. 29, 2011, titled “Generating Hogel Data from Voxel Data”, by Sean O'Connell, et al., U.S. Pat. No. 6,152,8737. The above-referenced patent application is hereby incorporated by reference herein in its entirety.

### TECHNICAL FIELD

The invention relates generally to generating and distributing voxel data for the generation of hogel data.

### Background Art

Holographic 3D displays—also known as hogel light modulators—are generally configured to receive 3D data from one or more applications in a language such as OpenGL or DirectX and to generate a 3D holographic representation of such data. Depending on the complexity of the scene, the motion present in each frame, etc., there can be very large variability in the rate at which data is being received and processed by the hogel light modulator. Such variability can result in undesirable variations in the quality of the 3D image and/or the refresh rate in which the 3D image is being updated. Therefore, systems and methods are desired that can provide greater data rate predictability and consistency for the hogel light modulator and thus provide a more predictable experience.

### SUMMARY OF INVENTION

In one respect, disclosed is a method including receiving a set of voxel data, the set of voxel data having a set of attributes that is dependent on one or more performance characteristics of a hogel light modulator. Hogel data is generated using the set of voxel data for displaying on the hogel light modulator.

In another respect, disclosed is a system including one or more processors and one or more memory units coupled to the one or more processors. The system is configured to receive a set of voxel data, the set of voxel data having a set of attributes that is dependent on one or more performance characteristics of a hogel light modulator. The system is also configured to generate hogel data using the set of voxel data for displaying on the hogel light modulator.

In yet another respect, disclosed is a computer program product embodied in a non-transitory computer-readable medium, the computer program product comprising logic instructions that are effective to receive a set of voxel data, the set of voxel data having set of attributes that is dependent on one or more performance characteristics of a hogel light modulator. Hogel data is generated using the set of voxel data for displaying on the hogel light modulator.

Numerous additional embodiments are also possible.

### BRIEF DESCRIPTION OF THE DRAWINGS

Other objects and advantages of the invention may become apparent upon reading the detailed description and upon reference to the accompanying drawings.

FIG. 1 is a block diagram illustrating a system for generating hogel data using voxel data, in accordance with some embodiments.

FIG. 2 is a block diagram illustrating an alternative system for generating hogel data using voxel data, in accordance with some embodiments.

FIG. 3 is a block diagram illustrating a yet another alternative system for generating hogel data using voxel data, in accordance with some embodiments.

FIG. 4 is a flow diagram illustrating a method for generating hogel data using voxel data, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### DESCRIPTION OF EMBODIMENTS

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

In some embodiments, systems and methods are disclosed for generating hogel data from voxel data. In some embodiments, a set of voxel data is received, the set of voxel data having properties that are dependent on one or more performance characteristics of a hogel light modulator that is to display the generated hogel data.

A voxel (volumetric pixel or Volumetric Picture Element) is a volume element, representing a value on a regular grid in three dimensional space. This is analogous to a pixel, which represents 2D image data in a bitmap (which is sometimes referred to as a pixmap). As with pixels in a bitmap, voxels themselves do not typically have their position (their coordinates) explicitly encoded along with their values. Instead, the position of a voxel is inferred based upon its position relative to other voxels (i.e., its position in the data structure that makes up a single volumetric image). In contrast to pixels and voxels, points and polygons are often explicitly represented by the coordinates of their vertices. A direct consequence of this difference is that polygons are able to efficiently represent simple 3D structures with lots of empty or homogeneously filled space, while voxels are good at representing regularly sampled spaces that are non-homogeneously filled.

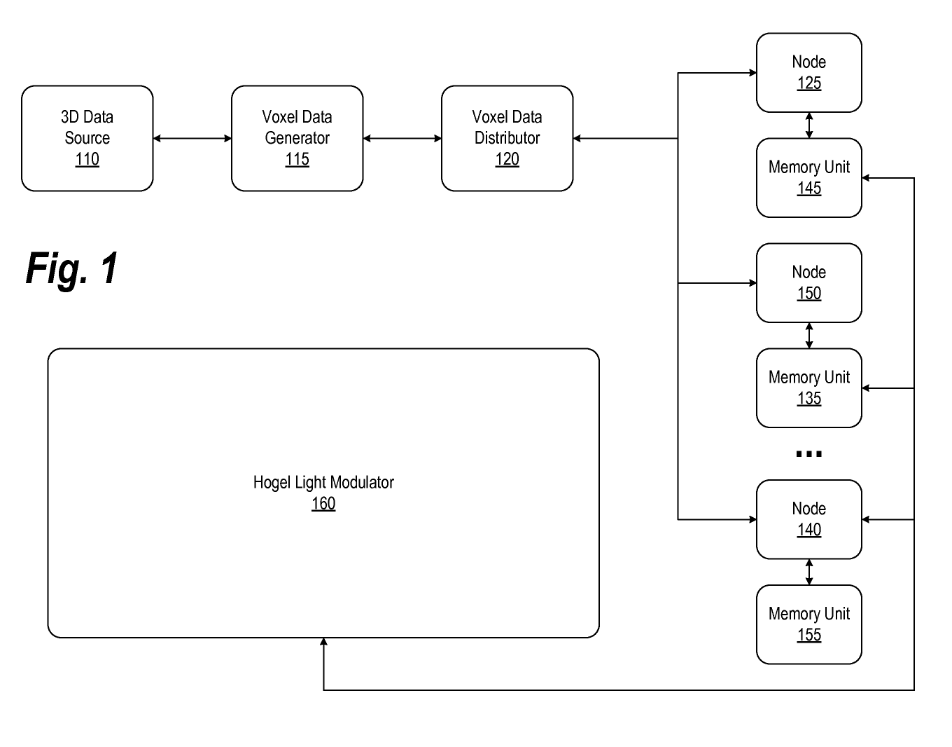

FIG. 1 is a block diagram illustrating a system for generating hogel data using voxel data, in accordance with some embodiments.

In some embodiments, 3D data source 110 is configured to provide 3D data to voxel data generator 115. In some embodiments, 3D data source may be a workstation executing a 3D software application, generating 3D data in a graphics language such as OpenGL or DirectX. Voxel data generator 115 is configured to receive the 3D data and to convert the 3D data to voxel data.

Voxel data distributor 120 is configured to receive the voxel data and to send the voxel data to nodes 125, 150, . . . , and 140. Nodes 125, 150, . . . , and 140 are configured to receive the voxel data and store a copy of the voxel data in memory units 145, 135, . . . , and 155. Each node is then configured to generate a subset of the hogel data using the stored copy of the voxel data. The generated hogel data may be then displayed on hogel light modulator 160.

3D datasets can vary greatly in size and complexity, and as a result, converting the 3D data directly into hogel data can yield unpredictable times to render each hogel. Such unpredictable rendering times may make it difficult to design a system with hogel light modulator and nodes having the right memory and power requirements. Alternatively, a more predictable approach involves converting the 3D data first into voxel data of predetermined size and complexity. This predictable voxel data stream may be then distributed to the multiple nodes, which may be accordingly designed with specific power and memory requirements that match the predictable size and complexity of the voxel data.

In some embodiments, systems and methods are disclosed for generating hogel data from voxel data. In some embodiments, raycasting methods may be used to generate the hogel data from the voxel data. In alternative embodiments, other known methods may be used to generate the hogel data such as rasterization or scanline rendering methods.

In some embodiments, voxel data is generated and provided to the system from 3D data, which may be itself generated by a 3D application. In some embodiments, graphics languages such OpenGL and DirectX may be used to represent the 3D data generated by the application. The voxel data may be generated using known methods for generating such data and may be provided in one of many formats such as uncompressed data, DXT, Sparse Voxel Octree, etc. The voxel data may be generated at a single workstation from data provided by the 3D application executing on the workstation. Alternatively, multiple workstations may be used and/or other auxiliary systems.

In some embodiments, various attributes of the voxel data may be determined according to the performance characteristics of hogel light modulator 160 and attached nodes (such as nodes 125, 150, . . . , and 140). Performance characteristics may include the number of hogel beams generated by the hogel light modulator, the number of hogel beams per hogel for the light modulator, the number of colors generated by the hogel light modulator, the frame refresh rate of the hogel light modulator, etc.

The voxel data may be then provided to voxel data distributor 120, which is configured to distribute the data to the one or more nodes. In some embodiments, nodes 125, 150, . . . , and 140 are configured to receive and store the voxel data. Each node is further configured to generate a subset of hogel data from the voxel data. In some embodiments, the nodes are configured to generate the hogel data from the voxel data using ray casting rendering methods. Alternatively, rasterization rendering methods may be used. The resulting hogel data may be then displayed on a hogel light modulator.

For additional discussion on hogels and hogel light modulators, please see U.S. patent application Ser. No. 12/258,438, filed 26 Oct. 2008, entitled “Systems and Methods for Calibrating a Hogel Display” and naming Mark E. Lucente as inventor. The above-referenced patent application is hereby incorporated by reference herein in its entirety. In embodiments where other types of 3D data are to be converted into hogel data, other types of appropriate processing devices may be used in the place of graphics processing units as needed.

In some embodiments, the nodes may be implemented using off-the-shelf GPUs, CPUs, hybrid chips, etc. In other embodiments, combinations of hardware and software may be used. FPGAs or other programmable hardware devices may also be designed for the task of rendering the hogel data.

In some embodiments, the voxel data distribution may be performed in a hierarchical manner where the number of levels would be determined based on achievable memory bandwidth.

In some embodiments, data transfers between voxel data distributor 120 and nodes 125, 150, . . . , and 140 may be minimized by transferring only subsets of the voxel data as the subset is modified. For example, if view transformations take place on the workstation, a point matrix may be transferred and applied to the voxel data by each node as each node is rendering the hogel data.

In some embodiments, the rendering processes within each node may be optimized for a specific voxel data format. In some embodiments, the workstation and/or other attached auxiliary systems may assist in converting the voxel data from one format to another, such as converting raw uncompressed voxel datasets to other data formats. Data formats may include, but are not limited to: uncompressed, DXT-based image compression, and Sparse Voxel Octrees.

In some embodiments, software applications executing on the workstation may convert their 3D scene content to the appropriate voxel data format. In other embodiments, the conversion may occur on attached auxiliary systems or a combination of auxiliary systems and the workstation. Custom graphics middleware drivers may be used to extract the voxel data from compatible software applications without modifying the original code base of that software. In some embodiments, the graphics language (such as OpenGL or DirectX) middleware driver may perform the conversion entirely on the workstation. In alternative embodiments, the graphics middleware driver may transfer necessary information about the software application to the attached auxiliary systems, which may then perform the conversion. The resulting voxel dataset may be transferred back to the workstation before being sent to voxel data distributor 120.

In some embodiments, nodes may be designed and optimized for raycasting voxel datasets into hogel data. A minimal software stack may be used to alleviate the need for an operating system, hard drive, and other peripherals.

In some embodiments, the transport protocol between the work station and the voxel data distributor may support a variety of data formats, data resolutions, and control mechanisms. The data stream may also contain a header specifying metadata, such as dynamic data resolution adjustment, data format (i.e. compression method), view transformation via a floating point matrix, firmware updates, calibration data, general feedback data, etc. In some embodiments, the transfer protocol may be bi-directional so feedback may be supported for the purposes of system status, etc.

In some embodiments, a single memory bank may be used in place of distributing the voxel data to each node. In such embodiments, each node may be granted read-only access to the memory bank, and a parallel access to the memory bank may be set up for each of the nodes.

In some embodiments, groups of nodes may share a memory bank, with parallel access being set up for all the nodes in the group.

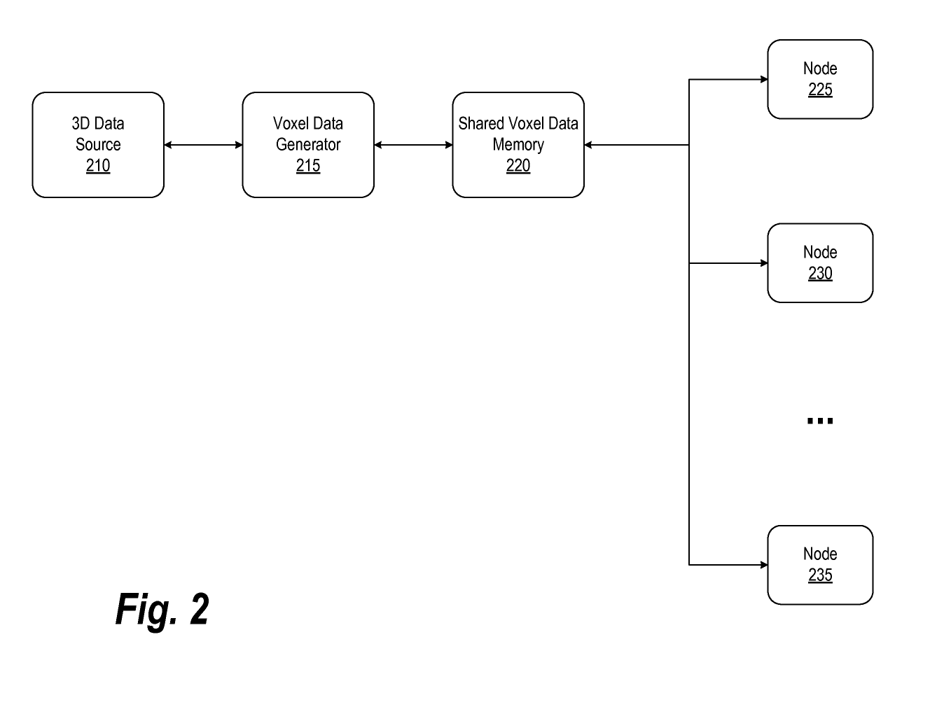

FIG. 2 is a block diagram illustrating an alternative system for generating hogel data using voxel data, in accordance with some embodiments.

In some embodiments, 3D data source 210 is configured to provide 3D data. In some embodiments, 3D data source may be a workstation executing a 3D software application using a graphics language such as OpenGL or DirectX. Voxel Data generator 215 is configured to receive the 3D data and to convert the 3D data to voxel data.

Voxel data generator is configured to store the voxel data in shared voxel data memory 220. Nodes 225, 230, . . . , and 235 are configured to each access, in parallel, the voxel data from voxel data memory 220. Each node is then configured to generate a subset of the hogel data using raycasting and the voxel data.

In such embodiments, individual storage units for each node may not be required as each node may access the voxel data in parallel with the other nodes from shared voxel data memory 220.

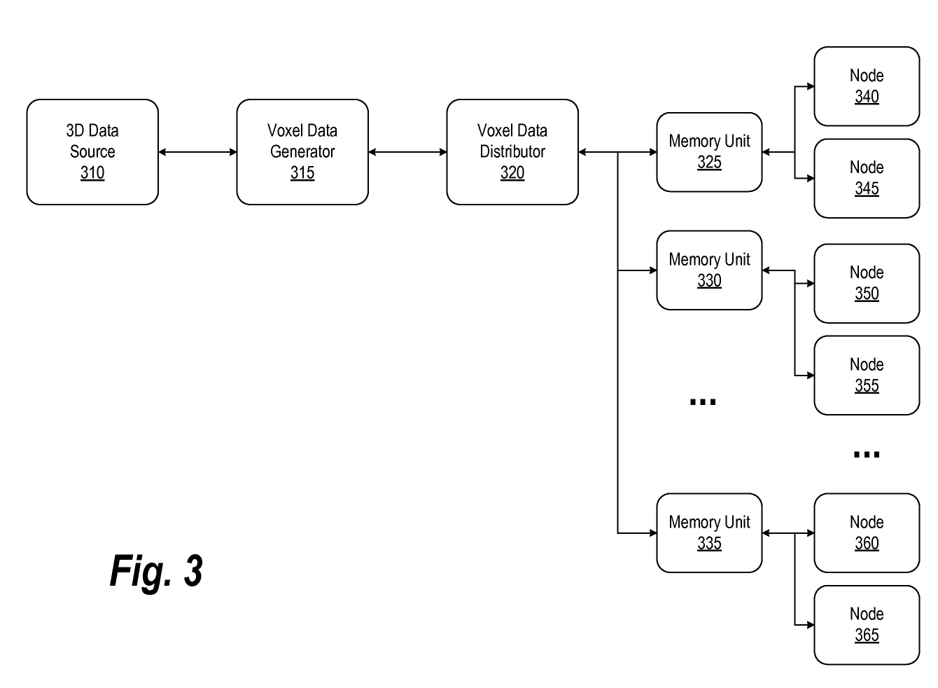

FIG. 3 is a block diagram illustrating a yet another alternative system for generating hogel data using voxel data, in accordance with some embodiments.

In some embodiments, 3D data source 310 is configured to provide 3D data. In some embodiments, 3D data source may be a workstation executing a 3D software application using a graphics language such as OpenGL or DirectX. Voxel Data generator 315 is configured to receive the 3D data and to convert the 3D data to voxel data.

Voxel data distributor 320 is configured to receive the voxel data and to send the voxel data to memory units 325, 330, . . . , and 335. Nodes 340 and 345 are configured to access the voxel data in parallel from memory unit 325, nodes 350 and 355 are configured to access the voxel data in parallel from memory unit 330, . . . , and nodes 360 and 365 are configured to access the voxel data in parallel from memory unit 335. Each node is then configured to generate a subset of the hogel data using raycasting on the stored copy of the voxel data.

In such embodiments, less storage memory is required at the node level as two (or more in other embodiments) nodes share a memory unit.

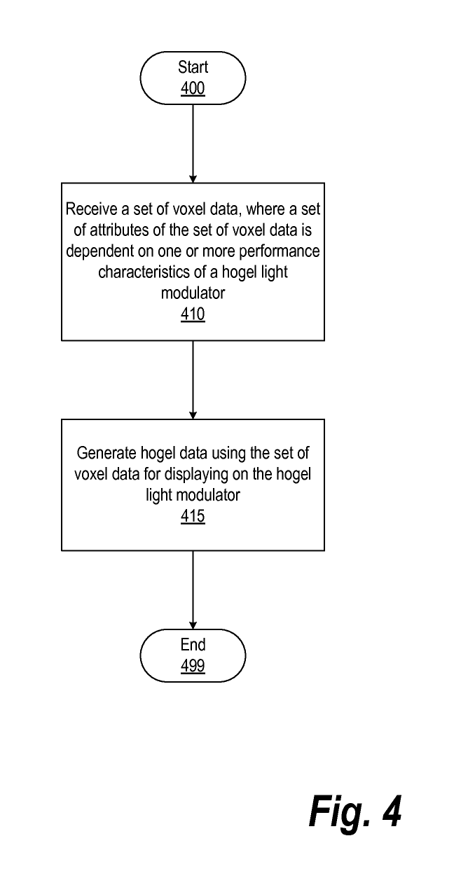

FIG. 4 is a flow diagram illustrating a method for generating hogel data using voxel data, in accordance with some embodiments.

In some embodiments, the method illustrated in this figure may be performed by one or more of the systems illustrated in FIGS. 1, 2, and 3.

Processing begins at 400 whereupon, at block 410 a set of voxel data is received. In some embodiments, a set of attributes of the set of voxel data is dependent on one or more performance characteristics of a hogel light modulator.

At block 415, hogel data is generated using the set of voxel data for displaying on the hogel light modulator.

Processing subsequently ends at 499.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method comprising:
receiving a set of voxel data, where a set of attributes of the set of voxel data is dependent on one or more performance characteristics of a hogel light modulator system;
generating hogel data using the set of voxel data for displaying on the hogel light modulator system.

2. The method of claim 1, where generating the set of hogel data comprises at least one of:
using raycasting rendering, and
using rasterization rendering.

3. The method of claim 1, where the set of attributes of the voxel data comprises at least one of:
the number of hogel beams generated by the hogel light modulator system,
the number of hogel beams per hogel for the hogel light modulator system,
the number of colors generated by the hogel light modulator system,
the frame refresh rate of the hogel light modulator system.

4. The method of claim 1, further comprising distributing the voxel data to one or more nodes, and generating subsets of the hogel data at each of the nodes.

5. The method of claim 4, where groups of the nodes receives a copy of the voxel data.

6. The method of claim 4, where each of the nodes receives a copy of the voxel data.

7. The method of claim 4, where the voxel data is streamed directly to each of the nodes.

8. A system for generating hogel data, the system comprising:
one or more processors;
one or more memory units coupled to the one or more processors;
the system being configured to:
receive a set of voxel data, where a set of attributes of the set of voxel data is dependent on one or more performance characteristics of a hogel light modulator system;
generate hogel data using the set of voxel data for displaying on the hogel light modulator system.

9. The system of claim 8, where the system being configured to generate the set of hogel data comprises the system being configured to perform at least one of:
use raycasting rendering, and
use rasterization rendering.

10. The system of claim 8, where the set of attributes of the voxel data comprises at least one of:
the number of hogel beams generated by the hogel light modulator system,
the number of hogel beams per hogel for the hogel light modulator system,
the number of colors generated by the hogel light modulator system,
the frame refresh rate of the hogel light modulator system.

11. The system of claim 8, the system being further configured to distribute the voxel data to one or more nodes, and generate subsets of the hogel data at each of the nodes.

12. The system of claim 11, where groups of the nodes receives a copy of the voxel data.

13. The system of claim 11, where each of the nodes receives a copy of the voxel data.

14. The system of claim 11, where the voxel data is streamed directly to each of the nodes.

15. A computer program product embodied in a non-transitory computer-readable medium, the computer program product comprising logic instructions, the logic instructions being effective to:
receive a set of voxel data, where a set of attributes of the set of voxel data is dependent on one or more performance characteristics of a hogel light modulator system;
generate hogel data using the set of voxel data for displaying on the hogel light modulator system.

16. The product of claim 8, where the logic instructions being effective to generate the set of hogel data comprises the system being configured to perform at least one of:
use raycasting rendering, and
use rasterization rendering.

17. The product of claim 8, where the set of attributes of the voxel data comprises at least one of:
the number of hogel beams generated by the hogel light modulator system,
the number of hogel beams per hogel for the hogel light modulator system,
the number of colors generated by the hogel light modulator system,
the frame refresh rate of the hogel light modulator system.

18. The product of claim 8, the logic instructions being effective to distribute the voxel data to one or more nodes, and generate subsets of the hogel data at each of the nodes.

19. The product of claim 11, where groups of the nodes receives a copy of the voxel data.

20. The product of claim 11, where each of the nodes receives a copy of the voxel data.

21. The product of claim 11, where the voxel data is streamed directly to each of the nodes.
